(19) United States
(12) Patent Application Publication
(10) Pub. No.: US 2024/0397289 A1
(43) Pub. Date: Nov. 28, 2024

(54) METHOD AND DEVICE FOR PROVIDING PUSH-TO-TALK (PTT) SERVICE

(71) Applicant: Samsung Electronics Co., Ltd., Suwon-si (KR)

(72) Inventors: Md. Imtiaz HOSSAIN, Dhaka (BD); Md. Zahid Hasan POLIN, Dhaka (BD)

(21) Appl. No.: 18/673,930

(22) Filed: May 24, 2024

Related U.S. Application Data
(63) Continuation of application No. PCT/KR2024/006989, filed on May 23, 2024.

(30) Foreign Application Priority Data
May 26, 2023 (KR) 10-2023-0068157
Jun. 8, 2023 (KR) 10-2023-0073488

(51) Int. Cl. H04W 4/10; H04W 4/029

(52) U.S. Cl. CPC H04W 4/10; H04W 4/029

(57) ABSTRACT

A method for providing a push-to-talk (PTT) service by a server is provided. The method may include: identifying a position related to an event, receiving a floor request from one or more of at least one user of a group for the PTT service, identifying a position of each of the at least one user, and allocating a floor to the at least one user, based on the identified position related to the event and a priority corresponding to the identified position of each of the at least one user.

### CROSS-REFERENCE TO RELATED APPLICATIONS

This application is a continuation of International Application No. PCT/KR2024/006989 designating the United States, filed on May 23, 2024, in the Korean Intellectual Property Receiving Office and claiming priority to Korean Patent Application Nos. 10-2023-0068157, filed on May 26, 2023, and 10-2023-0073499, filed on Jun. 8, 2023, in the Korean Intellectual Property Office, the disclosures of each of which are incorporated by reference herein in their entireties.

### BACKGROUND

### Field

The disclosure relates to a method and a device for providing a push-to-talk (PTT) service.

### Description of Related Art

A PTT service provides a call function to users in a PTT group. In a PTT group call, only one user in a PTT group is allowed to talk within a given time, and all the remaining users are able to do is listen to what the one user is saying. As described above, in a PTT service, a particular user's authority to speak may be referred to as a floor.

Determining which user to be granted a floor may be referred to as floor control. In a PTT service via an on-network, a floor control service (e.g., mission critical push-to-talk (MCPTT)) on the network may perform floor control. In a PTT service via an off-network, there is no particular floor control server, and a current speaker may perform a function of a floor control server.

In a conventional MCPTT system, a priority for the floor is assigned to each of members in a PTT group. Floor control may be performed based on the priority, and a member having a higher priority may obtain a floor earlier than a member having a lower priority. For example, if a member having a priority higher than that of a member having a current floor requests a floor, the floor is successfully interrupted or preempted and then allocated to the member having the higher priority. If a member having a priority equal to or lower than that of a member having a current floor requests a floor, interruption or preemption of the floor is impossible. If a member having a priority equal to or lower than that of a member having a current floor requests a floor, the floor request is queued and a floor request of the same priority may be processed on a first-come, first-served basis.

FIG. 1 and FIG. 2 are diagrams illustrating a floor allocation method according to the prior art.

Referring to FIG. 1 and FIG. 2, a VIP may move according to a designated route, and security guards A, B, C, D, E, F and G may be placed on the designated route. The security guards may belong to a PTT group, each of the security guards may have a default floor priority pre-determined by a supervisor, and the default floor priorities of the security guards may be the same.

As the VIP moves, a security guard adjacent to the VIP is required to have a high authority to speak, to notify of an event having occurred for the VIP. For example, in FIG. 1, security guard A needs to have a high authority for the VIP, and in FIG. 2, security guard G is required to have a high authority. However, in a case where each of the security guards may have a default floor priority, even if a security guard adjacent to the VIP needs to speak, the security guard is unable to interrupt or preoccupy another security guard having a higher or identical floor priority while the other security guard is speaking.

Therefore, a method for dynamically assigning a priority for a floor is required.

### SUMMARY

Embodiments of the disclosure may provide a method and a device for dynamically assigning a priority for a floor in a PTT system.

According to an example embodiment of the disclosure, a method for providing a push-to-talk (PTT) service by a server is provided. The method may include: identifying a position related to an event; receiving a floor request from each of at least one user of a group for the PTT service; identifying a position of each of the at least one user; allocating a floor to the at least one user, based on the identified position related to the event and a priority corresponding to the identified position of each of the at least one user.

The at least one user may initially have an identical priority for the floor.

The floor request may include information on the position of a user who has transmitted the floor request.

The allocating of the floor may include: allocating the floor to a user closest to the identified position related to the event among the at least one user, based on the identified position related to the event and the identified position of each of the at least one user.

The position of each of the at least one user may be identified in response to receiving of the floor request from the each of the at least one user.

The method may further include: identifying that an existing floor is released from a user having the existing floor in the group; and based on identifying that the existing floor is released, the floor may be allocated to a user closest to the identified position related to the event among the at least one user.

The allocating of the floor may include: identifying that a distance between the identified position related to the event and the position of a first user among the at least one user is less than a threshold; and allocating the floor to the first user, based on identifying that the distance between the identified position related to the event and the position of the first user is less than the threshold.

The allocating of the floor to the first user may include: revoking an existing floor from a user having the existing floor in the group; and based on revoking the existing floor, allocating the floor to the first user.

Based on the identified position related to the event corresponding to an area, a user positioned within the area among the at least one user may have a priority for the floor higher than that of a user positioned outside the area.

The allocating of the floor may include assigning priorities for the floor to users positioned at an identical distance from the identified position related to the event according to an order in which the floor request is received.

According to an example embodiment of the disclosure, a server for providing a push-to-talk (PTT) service is provided. The server may include: memory storing instructions, and at least one processor configured to, when executing the instructions, perform operations. The operations may include identifying a position related to an event; receiving a floor request from each of at least one user of a group for the PTT service; identifying a position of each of the at least one user; and allocating a floor to the at least one user, based on the identified position related to the event and a priority corresponding to the identified position of each of the at least one user.

According to an example embodiment of the disclosure, a non-transitory computer-readable storage medium storing instructions may be provided. The instructions may, when executed by at least one processor of a server for providing a push-to-talk (PTT) service, cause the server to execute operations. The operations may include: identifying a position related to an event; receiving a floor request from each of at least one user of a group for the PTT service; identifying a position of each of the at least one user; and allocating a floor to the at least one user, based on the identified position related to the event and a priority corresponding to the identified position of each of the at least one user.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 and FIG. 2 are diagrams illustrating a floor allocation method according to the prior art;

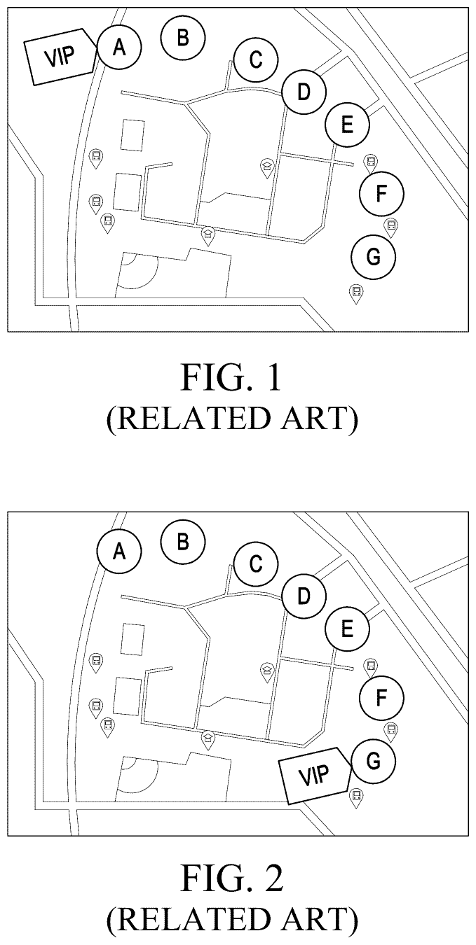

FIG. 3 and FIG. 4 are diagrams illustrating a floor allocation method according to various embodiments;

FIG. 5 is a signal flow diagram illustrating an example floor allocation method according to various embodiments;

FIG. 6 is a diagram illustrating an example floor allocation method according to various embodiments;

FIG. 7 is a signal flow diagram illustrating an example floor allocation method according to various embodiments;

FIG. 8 is a diagram illustrating an example floor allocation method according to various embodiments;

FIG. 9A and FIG. 9B are diagrams illustrating examples of application of a floor allocation method according to various embodiments;

FIG. 10 is a diagram illustrating an example application of a floor allocation method according to various embodiments;

FIG. 11 is a diagram illustrating an example of application of a floor allocation method according to various embodiments;

FIG. 12 is a flowchart illustrating an example floor allocation method according to various embodiments; and

FIG. 13 is a block diagram illustrating an example configuration of a server according to various embodiments.

### DETAILED DESCRIPTION

Hereinafter, the operation principle of various example embodiments of the disclosure will be described in greater detail with reference to the accompanying drawings. The same or like elements illustrated on the drawings are designated by the same or like reference numerals as much as possible even though they are illustrated on different drawings. In the following description, a detailed description of known functions or configurations incorporated herein may be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the disclosure.

Various changes and modifications may be made to the disclosure, and the disclosure may have various embodiments, but particular embodiments illustrated in the drawings will be described in detail. However, it should be appreciated that the various example embodiments are not intended to limit the disclosure to particular embodiments and the disclosure include various changes, equivalents, or alternatives falling within the sprit and scope of the disclosure.

As used here in, it will be understood that the singular expressions “a”, “an”, and “the” includes plural expressions unless the context clearly indicates otherwise. Therefore, for example, “a component surface” includes one or more component surfaces.

The terms including an ordinal number, such as expressions “a first” and “a second” may be used to described various elements, but the corresponding elements should not be limited by such terms. These terms are used merely to distinguish between one element and any other element. For example, a first element may be termed a second element, and similarly, a second element may be termed a first element without departing from the scope of the disclosure. The term “and/or” includes a combination or any one of a plurality of relevant items enumerated.

The terms as used in an embodiment of the disclosure are merely used to describe specific embodiments, and are not intended to limit the disclosure. A singular expression may include a plural expression unless they are definitely different in a context. As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Unless separately defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in embodiments of the disclosure.

A user or users mentioned in the disclosure may practically indicate an electronic device that is manipulated by a user to receive a PTT service.

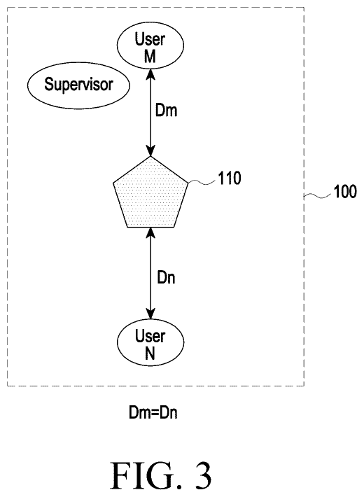

FIG. 3 and FIG. 4 are diagrams illustrating an example floor allocation method according to various embodiments.

Referring to FIG. 3 and FIG. 4, user M, user N, an event 110, and a supervisor may be located in a designated area 100. User M and user N may belong to a PTT group. The supervisor may supervise or manage users in the PTT group. The supervisor may also belong to the PTT group. Initially, the same priority may be assigned to user M and user N for a floor.

As illustrated in FIG. 3, if a distance (Dm) between user M and the position of the event 110 and a distance (Dn) between user N and the position of the event 110 are the same, the priority of user M and the priority of user N may be maintained to be the same. If the priority of user M and the priority of user N are the same, a floor request of user M and a floor request of user N may be processed according to a first-come, first-served basis.

As illustrated in FIG. 4, if the position of the event 110 is changed and thus the distance (Dm) between user M and the position of the event 110 is greater than the distance (Dn) between user N and the position of the event 110, a priority for the floor higher than that of user M may be assigned to user N closer to the position of the event 110. In this case, when both user N and user M request a floor, the floor request of user N may be preferentially processed.

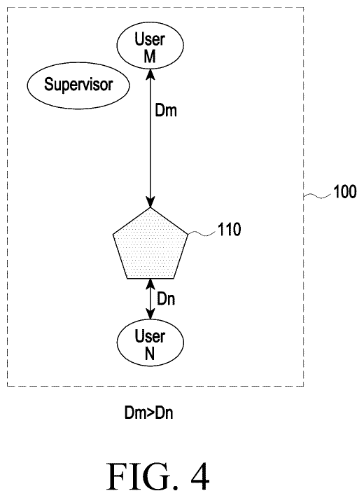

FIG. 5 is a signal flow diagram illustrating an example floor allocation method according to various embodiments. In a floor allocation method described with reference to FIG. 5, a high priority is granted to a user closer to the position of an event as described with reference to FIG. 3 and FIG. 4.

An MCPTT server (position server) may update the position of an event from a supervisor or a satellite (operation 505). Updating of the position of an event may be periodically or aperiodically and continuously performed.

User A has a floor and may transmit media (operation 510). User A may transmit media to an MCPTT server (media server), and the MCPTT server (media server) may transmit the media received from user A to members (e.g., supervisor, user M, and user N) of a PTT group.

The MCPTT server (position server) and the MCPTT server (media server) may be implemented in a single server. The MCPTT server (position server) and the MCPTT server (media server) may be implemented as individual servers.

User N may transmit a floor request to the MCPTT server (media server) (operation 515). The floor request may include a user ID (e.g., user N), a floor priority (e.g., 3), and information on a current position of user N.

The MCPTT server (media server) may respond to the floor request from user N to queue the floor request of user N (operation 520). For example, a first position may be assigned for the floor request of user N.

The MCPTT server (media server) may notify user N of a position in a queue (operation 525).

User M may transmit a floor request to the MCPTT server (media server) (operation 530). The floor request may include a user ID (e.g., user M), a floor priority (e.g., 3), and information on a current position of user N.

If user M and user N has the same priority, the MCPTT server (media server) may request the position of the event from the MCPTT server (position server) (operation 535) and, accordingly, obtain information on the position of the event from the MCPTT server (position server).

The MCPTT server (media server) may arrange the positions of users in the queue, based on the distance between the position of the event and each user (operation 540). For example, if the distance between user M and the position of the event is less than the distance between user N and the position of the event, the floor requests in the queue may be arranged such that a position before that of the floor request of user N who has transmitted the floor request earlier is assigned to the floor request of user M who has transmitted the floor request later. Therefore, a user closer to the position of the event may preferentially have a floor.

The MCPTT server (media server) may notify the changed position in the queue to each user (operations 545 and 550).

The MCPTT server (media server) may receive a floor release 555 from user A. When the floor of the existing user A is released, the MCPTT server (media server) may approve a floor for a user (e.g., user M) for the foremost floor request in the queue (operation 560).

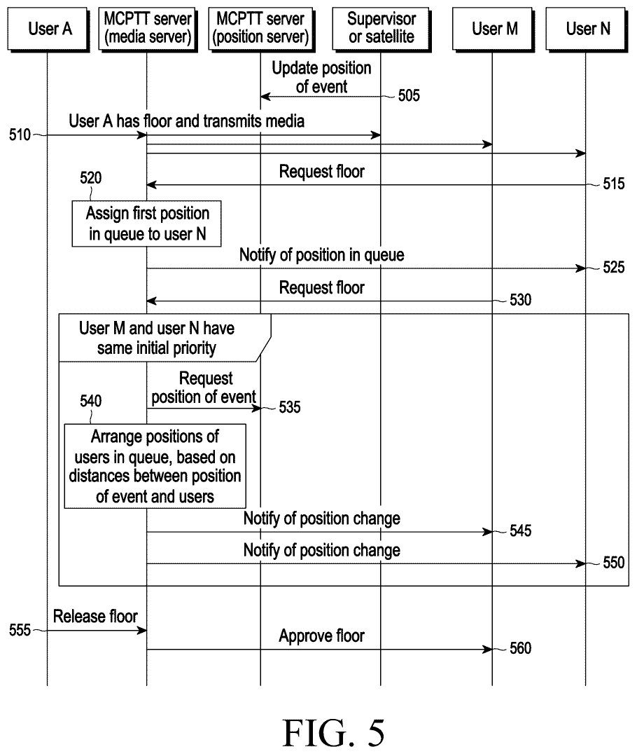

FIG. 6 is a diagram illustrating an example floor allocation method according to various embodiments.

The position of the event 110 may be continuously changed. According to the change of the position of the event 110, if the position of the event 110 and a random user in a PTT group is less than a threshold, a high priority for a floor may be assigned to the user. For example, if a distance (Dn) between the position of the event 110 and user N is less than a threshold, a high priority for a floor may be assigned to user N. User N having approached the event 110 within a distance shorter than the threshold may obtain an instantaneous access to a floor. That is, if another user has a current flow when user N requests a floor, the floor of the user may be revoked, and the floor may be immediately allocated to user N.

The example of FIG. 6 may be combined with the embodiments described with reference to FIG. 3 and FIG. 4. For example, if the distances between the position of the event 110 and all users in a PTT group are greater than a threshold, a queue may be arranged such that a user closer to the position of the event 110 is positioned ahead in the queue, based on the distances between the position of the event 110 and the users, whereby a priority for a floor may be adjusted based on distance. If the change of the position of the event 110 or the change of at least one user's position causes the distance between a particular user and the position of the event 110 to be smaller than the threshold, a floor currently corresponding to a different user may be revoked and a floor may be instantly allocated to the user.

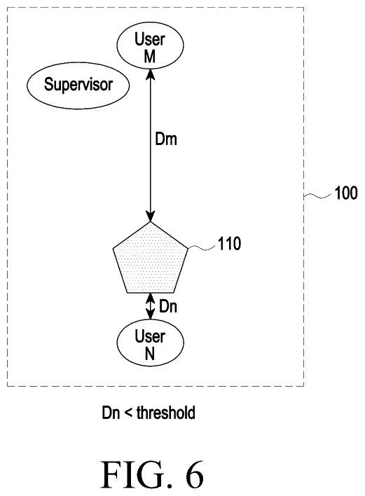

FIG. 7 is a signal flow diagram illustrating an example floor allocation method according to various embodiments.

An MCPTT server (position server) may update the position of an event from a supervisor or a satellite (operation 705). Updating of the position of an event may be periodically or aperiodically and continuously performed.

User A has a floor and may transmit media (operation 710). User A may transmit media to an MCPTT server (media server), and the MCPTT server (media server) may transmit the media received from user A to members (e.g., supervisor, user M, and user N) of a PTT group.

The MCPTT server (position server) and the MCPTT server (media server) may be implemented in a single server. The MCPTT server (position server) and the MCPTT server (media server) may be implemented as individual servers.

User N may transmit a position report to the MCPTT server (position server) (operation 715). The position report may include a user ID (e.g., user N) and information on a current position of the user. The position report may further include a floor priority (e.g., 3) for the user.

The MCPTT server (media server) may assign a position in a queue for a floor to user N if necessary (e.g., if a floor request is received from user N) (operation 720). If there is no request for a floor in the queue, a first position may be assigned to user N.

The MCPTT server (media server) may notify user N of the position (e.g., the first position) in the queue (operation 725).

User N may additionally transmit a position report to the MCPTT server (position server) (operation 730). The user's position report described above may be periodically or aperiodically and continuously performed. The position report may include a user ID (e.g., user N) and information on a current position of the user. The position report may further include a floor priority (e.g., 3) for the user.

The MCPTT server (position server) may determine that user N is within a threshold distance from the position of the event, based on the position report of user N and the updated position of the event (operation 735).

The MCPTT server (position server) may transmit a notification related to the threshold distance to the MCPTT server (media server) (operation 740). This notification may indicate a user (e.g., user N) positioned within the threshold distance from the position of the event.

When it is identified that user N is within the threshold distance from the position of the event, the MCPTT server (position server) may notify user N that floor preoccupancy is possible (operation 745).

After receiving the notification indicating that floor preoccupancy is possible, user N may transmit a floor request to the MCPTT server (media server). The floor request may include a user ID (e.g., user N), a floor priority (e.g., 3), and information on a current position of user N.

When a floor request is received from a user (e.g., user N) positioned within the threshold distance from the position of the event, the MCPTT server (media server) may revoke the floor of user A who has the current floor (operation 755) and approve a floor for user N (operation 760).

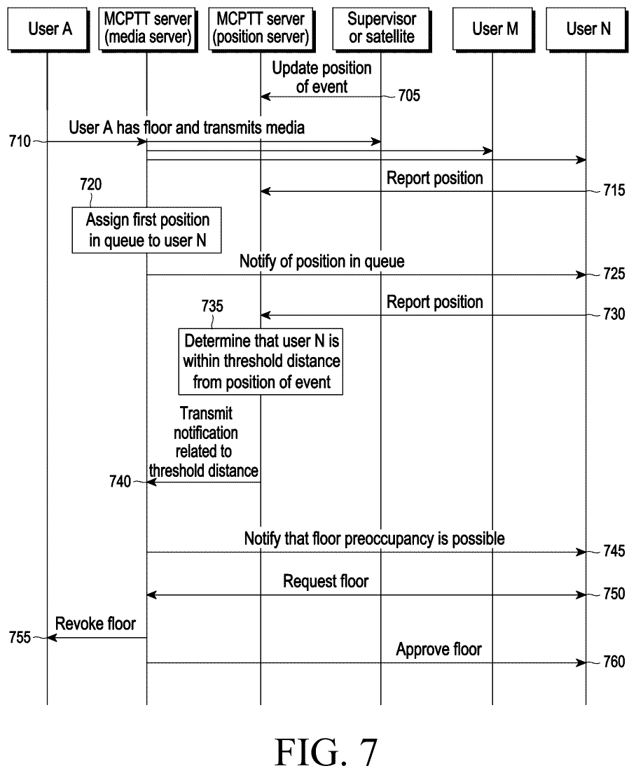

FIG. 8 is a diagram illustrating an example floor allocation method according to various embodiments.

An area 120 for an event may be defined. Users (e.g., user X, user Y, and user Z) positioned in the area 120 may have a priority for a floor higher than that of users (e.g., user M and user N) positioned outside the area 120.

For example, a queue for floor requests may be arranged such that a floor request from a user positioned in the area 120 is positioned in the queue before floor requests of users positioned outside the area 120.

For example, when a floor is requested from a user positioned in the area 120 and a user positioned outside the area 120 currently has a floor, the current floor may be revoked, and the floor requested from the user positioned in the area 120 may be approved.

Floor requests of users positioned in the area 120 may be processed on a first-come, first-served basis.

Embodiments described with reference to FIG. 8 may be combined with the embodiments described above with reference to FIG. 3, FIG. 4, and FIG. 6. For example, floor allocation between users outside the area 120 may be performed based on the embodiments of FIG. 3, FIG. 4, and FIG. 6. Here, the distance between a user outside the area 120 and the position of an event may be considered as the distance between the boundary of the area and the user, the distance between the center of the area and the user, or the distance between a particular position in the area and the user.

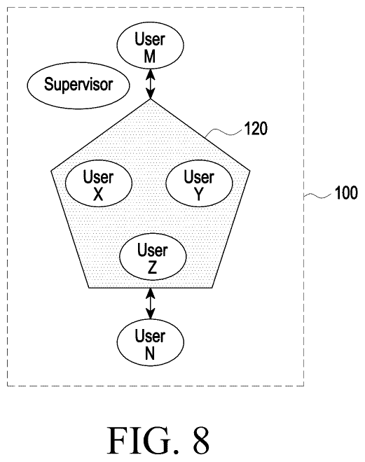

FIG. 9A and FIG. 9B are diagrams illustrating examples of application of an example floor allocation method according to various embodiments.

A vehicle with a VIP is moving from city 1 to city 2, and security guards may be placed on a possible route of the vehicle to ensure the safety of the VIP. The position of the vehicle and the positions of the security guards may be continuously notified to a position server.

As the vehicle is moving from city 1 to city 2, a priority for a floor of a security guard adjacent to the vehicle may be increased. For example, in FIG. 9A, security guard A more adjacent to the vehicle may have a priority higher than that of security guard B. In FIG. 9B, security guard B more adjacent to the vehicle may have a priority higher than that of security guard A.

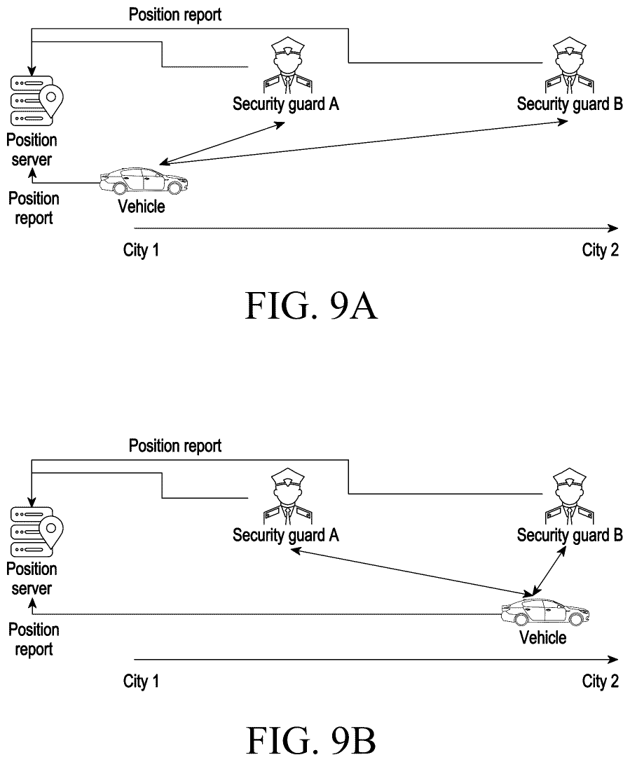

FIG. 10 is a diagram illustrating an example application of a floor allocation method according to various embodiments.

Disasters like fires and tornadoes do not stay in a specific location. These disasters may move based on various factors, such as topography and wind direction. Embodiments of the disclosure may also be applied to mobile disasters or incidents, such as fires or tornadoes.

If users, such as reporters, who wish to collect and transfer information about a disaster exist in a PTT group, a user adjacent to the disaster may be assigned a higher priority for a floor.

For example, a tornado may move from position 1 to position 2 and thus may be more adjacent to user B than to user A. In a case where the distance between the position of the tornado and user B is less than a threshold distance and user A currently has a floor, when user B requests a floor, the floor of user A is revoked, the floor is allocated to user B, and thus floor preemption of user B may be allowed.

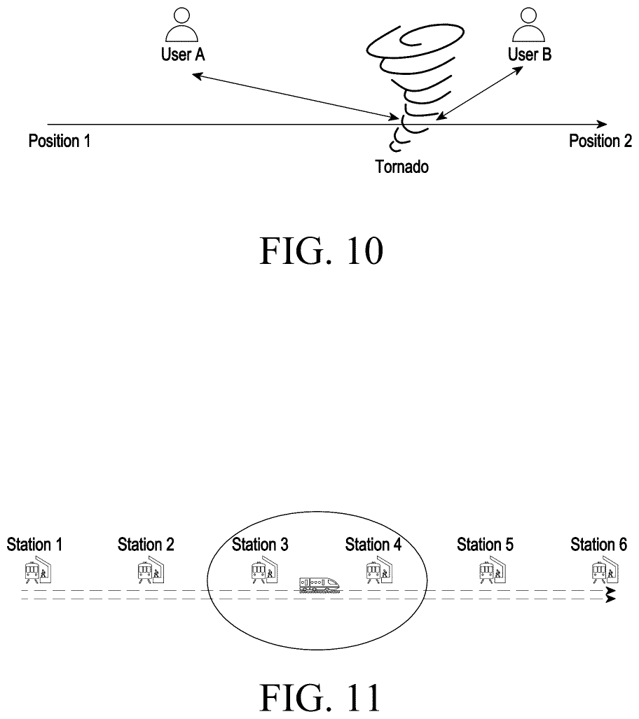

FIG. 11 is a diagram illustrating an example application of a floor allocation method according to various embodiments.

A PTT group may include users in stations located on a movement route of a train. An area (e.g., the area 120 in FIG. 8) related to a priority for a floor may be configured around the train according to a predetermined distance. For example, in a case where the train is moving from station 1 to station 6, the train is currently positioned between station 3 and station 4, and only station 3 and station 4 are included in the area, a user of station 3 and a user of station 4 may have a priority for a floor higher than those of users in the other stations.

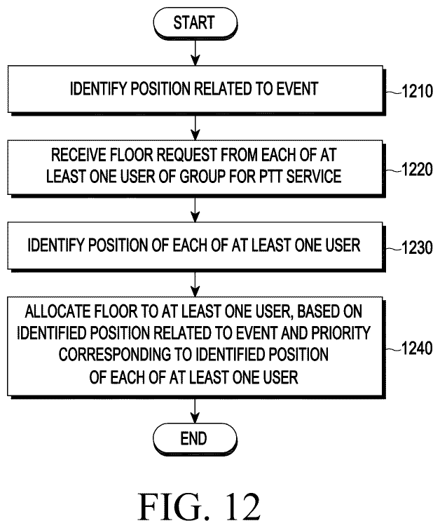

FIG. 12 is a flowchart illustrating an example floor allocation method according to various embodiments.

The floor allocation method of FIG. 12 may be performed by a server. The server may be a MCPTT floor control server. The MCPTT floor control server may be an MCPTT server (media server) or a server in which an MCPTT server (media server) and an MCPTT server (position server) are integrated, described above. In the disclosure, MCPTT is mentioned as an example, but the disclosure is applicable even to a PTT service not related to mission critical technology. For example, a server for performing the floor allocation method of FIG. 12 may include a server for providing or controlling a PTT service, independent of mission critical technology.

A server may identify a position related to an event (operation 1210). The position related to the event may be periodically or aperiodically identified. The position related to the event may be continuously identified. The server may use, to identify the position related to the event, a notification for a PTT group from a supervisor, information on the event from a satellite (e.g., the coordinates of the position of the event or an image of the event), and information on the position of the event from a position server.

The server may receive a floor request from each of at least one user of the group for PTT service (operation 1220). The floor request may include an ID of a user having transmitted the floor request and information on the position of the user. The floor request may further include information indicating a priority for a floor of the user.

The server may identify the position of each of the at least one user (operation 1230). The server may identify the position of a user having transmitted the floor request, based on the position information of the user included in the floor request. The server may identify the position of a user, based on a position report from the user, independent of the floor request. The server may use, to identify the position of the user, a notification from the supervisor, information on the user from a satellite (e.g., the coordinates of the position of the user or an image of the user), and information on the position of the user from the position server.

The server may allocate a floor to the at least one user, based on the identified position related to the event and a priority corresponding to the identified position of each of the at least one user (operation 1240).

For example, when floor requests are received from multiple users, the server may arrange a queue for the floor requests such that a floor request of a user close to the position related to the event is positioned ahead.

For example, when it is identified that a particular user is within a threshold distance from the position related to the event, and a floor request is received from the user positioned within the threshold distance from the position related to the event, the server may allow the user to preempt a floor. That is, the server may revoke a floor of a user having the current floor and allocate a floor to a user positioned within the threshold distance from the position related to the event.

For example, when the position related to the event includes an area for the event, the server may assign, to users in the area, priorities for a floor higher than those of users outside the area.

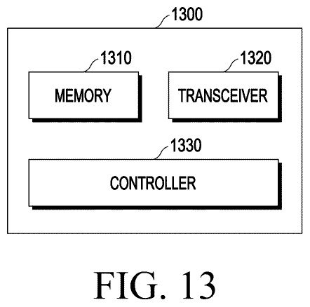

FIG. 13 is a block diagram illustrating an example configuration of a server according to various embodiments. A server 1300 may be a server that performs the operations of FIG. 12.

The server 1300 may include memory 1310, a transceiver (e.g., including circuitry) 1320, and a controller (e.g., including at least one processor comprising processing circuitry) 1330.

The memory 1310 may store at least one of information transmitted and/or received through the transceiver 1320 and information generated through the controller 1330. The memory 1310 may additionally store information/data/commands/instructions to be executed by the controller 1330 so that the server 1300 performs operations described herein. The memory 1310 may be refer, for example, to a non-transitory computer-readable storage medium.

The transceiver 1320 may include various circuitry and be used to transmit signals from the controller 1330 to other entities and/or receive signals from other entities. The transceiver 1320 may support communication using various radio access techniques (RATs) including, for example, long term evolution (LTE), wireless fidelity (Wi-Fi), orthogonal frequency division multiplexing (OFDM), code divisional multiple access (CDMA), and Bluetooth, and the RATs supported by the transceiver 1320 are not limited thereto.

The controller 1330 may include various processing circuitry (including at least one processor) and control operations of other elements of the server 1300. The operations of the server 1300 may be understood as being substantially executed by at least one processor of the controller 1330. The controller 1330 may be implemented by at least one processor. The controller may execute commands stored in the memory 1310 to perform operations of the server 1300 described herein. The at least one processor according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The elements included in the server 1300 have been described with reference to FIG. 13, but other devices (e.g., a user's device, a supervisor's device, etc.) mentioned in the disclosure may also include memory, a transceiver, and a controller, similarly to the server 1300.

While the disclosure has been illustrated and described with reference to various example embodiments, it will be understood that the various example embodiments are intended to be illustrative, not limiting. It will be further understood by those skilled in the art, that various modifications and changes may be made thereto without departing from the true spirit and full scope of the disclosure, including the appended claims and their equivalents. It will also be understood that any of the embodiment(s) described herein may be used in conjunction with any other embodiment(s) described herein.

What is claimed is:

1. A method for providing a push-to-talk (PTT) service by a server, the method comprising:
identifying a position related to an event;
receiving a floor request from one or more of at least one user of a group for the PTT service;
identifying a position of each of the at least one user; and
allocating a floor to the at least one user, based on the identified position related to the event and a priority corresponding to the identified position of each of the at least one user.

2. The method of claim 1, wherein the at least one user initially has an identical priority for the floor.

3. The method of claim 1, wherein the floor request comprises information on the position of a user who has transmitted the floor request.

4. The method of claim 1, wherein the allocating of the floor comprises allocating the floor to a user closest to the identified position related to the event among the at least one user, based on the identified position related to the event and the identified position of each of the at least one user.

5. The method of claim 1, wherein the position of each of the at least one user is identified in response to receiving of the floor request from the at least one of the at least one user.

6. The method of claim 1, further comprising identifying that an existing floor is released from a user having the existing floor in the group,
wherein, based on identifying that the existing floor is released, the floor is allocated to a user closest to the identified position related to the event among the at least one user.

7. The method of claim 1, wherein the allocating of the floor comprises:
identifying that a distance between the identified position related to the event and the position of a first user among the at least one user is less than a threshold; and
allocating the floor to the first user, based on identifying that the distance between the identified position related to the event and the position of the first user is less than the threshold.

8. The method of claim 1, wherein the allocating of the floor to the first user comprises:
revoking an existing floor from a user having the existing floor in the group; and
based on revoking the existing floor, allocating the floor to the first user.

9. The method of claim 1, wherein, based on the identified position related to the event corresponding to an area, a user positioned within the area among the at least one user has a priority for the floor higher than a priority of a user positioned outside the area.

10. The method of claim 1, wherein the allocating of the floor comprises assigning priorities for the floor to users positioned at an identical distance from the identified position related to the event based on an order in which the floor request is received.

11. A server configured to provide a push-to-talk (PTT) service, the server comprising:
memory storing instructions; and
at least one processor configured to, when executing the instructions, perform operations comprising:
identifying a position related to an event;
receiving a floor request from one or more of at least one user of a group for the PTT service;
identifying a position of each of the at least one user; and
allocating a floor to the at least one user, based on the identified position related to the event and a priority corresponding to the identified position of each of the at least one user.

12. The server of claim 11, wherein the at least one user initially has an identical priority for the floor.

13. The server of claim 11, wherein the at least one user initially has an identical priority for the floor.

14. The server of claim 11, wherein the allocating of the floor comprises allocating the floor to a user closest to the identified position related to the event among the at least one user, based on the identified position related to the event and the identified position of each of the at least one user.

15. The server of claim 11, wherein the position of each of the at least one user is identified in response to receiving of the floor request from the at least one of the at least one user.

16. The server of claim 11, wherein the operations further comprise identifying that an existing floor is released from a user having the existing floor in the group,
wherein, based on identifying that the existing floor is released, the floor is allocated to a user closest to the identified position related to the event among the at least one user.

17. The server of claim 11, wherein the allocating of the floor comprises:
identifying that a distance between the identified position related to the event and the position of a first user among the at least one user is less than a threshold; and
allocating the floor to the first user, based on identifying that the distance between the identified position related to the event and the position of the first user is less than the threshold.

18. The server of claim 11, wherein the allocating of the floor to the first user comprises:
revoking an existing floor from a user having the existing floor in the group; and
based on revoking the existing floor, allocating the floor to the first user.

19. The server of claim 11, wherein, based on the identified position related to the event corresponding to an area, a user positioned within the area among the at least one user has a priority for the floor higher than a priority of a user positioned outside the area.

20. A non-transitory computer-readable storage medium storing instructions, the instructions, when executed by at least one processor a server configured to provide a push-to-talk (PTT) service, causing the server perform operations, the operations comprising:
identifying a position related to an event;
receiving a floor request from one or more of at least one user of a group for the PTT service;
identifying a position of each of the at least one user; and
allocating a floor to the at least one user, based on the identified position related to the event and a priority corresponding to the identified position of each of the at least one user.
